(19) United States
(12) Patent Application Publication
(10) Pub. No.: US 2016/0373419 A1
(43) Pub. Date: Dec. 22, 2016

(54) USER-MANAGED SECURITY FOR DISPERSED NETWORK DATA STORAGE

(71) Applicants: Adam Mark Weigold, Stateline, NV (US); Raghunadha Reddy Kotha, Charlotte, NC (US)

(72) Inventors: Adam Mark Weigold, Stateline, NV (US); Raghunadha Reddy Kotha, Charlotte, NC (US)

(21) Appl. No.: 14/745,617

(22) Filed: Jun. 22, 2015

(51) Int. Cl. H04L 29/06; G06F 21/62; G06F 21/60

(52) U.S. Cl. CPC H04L 63/062; H04L 63/10; G06F 21/602; G06F 21/6218

(57) ABSTRACT

A system and method for a user-managed network security architecture that securely stores individual data files in a uniquely encrypted and dispersed manner, for specific application to wide area enterprise storage networks and online cloud storage networks. This user-managed file-orientated security philosophy combined with a dispersed enterprise network architecture provides for a software-only storage solution that has the potential to increase the overall level of enterprise network security, eliminate the liability related to external security breaches, dramatically reduce the liability related to internal security breaches, reduce the overall hardware costs for online data storage and security, and provide for software-only only platform installation requirements. Ultimately user-managed encrypted dispersed security technology has the potential to eliminate the vast majority of potential liabilities relating to both external and internal network security breaches and network data theft while also saving capital and operating costs.

### CROSS-REFERENCE TO RELATED APPLICATIONS

This application is related to and is a continuation-in-part under 35 USC sections 120, 365(e) and 119(e) of U.S. application Ser. No. 14/712,715 filed May 14, 2015 titled “SYSTEM AND METHOD FOR DIGITAL CURRENCY STORAGE, PAYMENT AND CREDIT”, which claims the priority benefit of U.S. Provisional Application No. 61/994,053 filed May 15, 2014, which is incorporated herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### STATEMENT REGARDING PRIOR DISCLOSURES BY A JOINT INVENTOR

Not Applicable

### BACKGROUND OF THE INVENTION

### 1—Field of the Invention

The present invention relates to a system and method for the secure online storage and network management of data on a wide area enterprise server network or online cloud server network, via an innovative user-managed security architecture that stores individual data files in an encrypted and dispersed manner on a data storage grid.

### 2—Description of Related Art

Conventional data storage on online cloud networks and large enterprise networks deployed over wide geographic areas generally incorporate a redundant array of independent disks (RAID) data storage architecture. Typical examples of RAID storage architectures are described by Wilks and Savage (1998) in U.S. Pat. No. 5,720,025, Craft (2004) in U.S. Pat. No. 6,678,768 and Weng (2006) in U.S. Pat. No. 6,148,430 and can be applied to independent disk storage drives in a single data server and also independent disk storage drives in geographically dispersed data servers. The most commonly used class of RAID architecture is RAID 6 which typically comprises multiple independent redundant disk drives at a minimum of four server sites including the primary server, an onsite mirror server, a remote mirror server and an offline back-up server site. An example of RAID 6 architecture is described by Frey, Jr. et al (2006) in U.S. Pat. No. 7,149,847, which demonstrates that by storing multiple redundant copies of data payloads in separate disk drives or server locations the network benefits from a high level of access reliability and data integrity, being able to withstand catastrophic events at up to two or more server sites at any one time. Unfortunately conventional RAID server architecture also suffers two major weaknesses in terms of high data storage hardware costs and increased vulnerability to potential security breaches. More than four petabytes of data storage hardware is required for every petabyte sized data payload stored on RAID 6 server networks. Moreover hackers only need to breach the security of a single online server to access all of the data files stored on the network. To summarize RAID storage architecture, it is a very good storage design for high network reliability and data integrity, but it is also cost inefficient and highly vulnerable to security breaches.

A recent improvement on conventional RAID architecture uses a method for subdividing or splicing data payloads for storage in multiple geo-locations on a network as part of a dispersed data storage grid, as described by Gladwin and England (2011) in U.S. Pat. No. 7,953,937 and Gladwin et al (2009) in U.S. Pat. No. 7,546,427. Payloads of data files in a dispersed data storage grid can only be rebuilt from the dispersed data payload portions into complete and usable data when access is specifically requested and authorized. Additional encryption, decryption and hashing of each portion of the data payload can significantly improve overall network security and data security. Moreover, instead of simply breaching a single online server on a network to gain access to all network data unauthorized hackers must now breach multiple (or even all) online server sites on the network to gain access to all of the network data. Consequently dispersed data storage grid architecture using multiple geographic server site locations can provide significantly improved levels of network security and data integrity against external breaches for slightly less hardware costs, while still providing the same level of network reliability, data redundancy and data integrity against catastrophic events typical of conventional RAID networks.

While dispersed network data storage architecture provides significantly improved protection against external security breaches of enterprise networks and online cloud networks, these dispersed networks still suffer three fundamental drawbacks in terms of (1) network latency and data access delays, (2) maximum potential liability in terms of data loss to external security breaches from unknown third parties, and (3) maximum potential liability in terms of data loss to internal security breaches from known parties such as employees.

First, to access data files dispersed in multiple, encrypted data payloads stored in different geo-locations on a wide area network requires complex software algorithms, significant server processing power and fast data communication speeds between different server sites. In practical terms this means that dedicated server hardware designed specifically to host a dispersed storage software engine is required to minimize network latency and data access delays. This necessitates that enterprise network customers purchase both server hardware and software from the platform vendor, thereby relegating existing legacy server hardware obsolete. It also precludes using third party cloud services to provide a cloud storage grid infrastructure underneath a software engine and storage platform.

Second, although successful theft of online data by an external party requires multiple security breaches of multiple (or even all) separate online sites, once successfully breached and decrypted the stolen data payload is completely vulnerable. In other words once the hacker has successfully hacked multiple (or even all) server sites he can then steal all the data files that are stored on the enterprise or cloud network. Consequently the maximum potential liability to successful external security breaches is still the total of all files contained on the entire network database (as with conventional RAID network storage architecture).

Third, the setting of user privacy, security and authorization levels for various network users is still managed via a central network administration which has complete control of all network security access for all users. This centralized administration architecture is particularly vulnerable to online theft from internal parties, especially network administrator employees and senior executive employees. Consequently the maximum potential liability to successful internal security breaches is still the total of all files contained on the entire network database (as with conventional RAID network storage architecture).

The inherent weaknesses of conventional RAID architecture relating to relatively high infrastructure costs and very high vulnerability to online security breaches are significant and growing in relevance. Currently global cyber-crime and online theft is estimated to cost in excess of US$500 billion in global financial losses annually, with more than one billion private records being compromised by global hacker groups every year according to a recent report by Gemalto N V titled “2014: Year of Mega Breaches and Identity Theft” (reference www.gemalto.com). While dispersed data storage architecture is slightly cheaper than RAID technology, and provides a greater barrier for preventing external security breaches, it still has some major fundamental drawbacks. As a complete hardware and software platform conventional dispersed storage architecture is only a good solution for green-field deployments that don't leverage existing enterprise or cloud hardware infrastructure to save costs. Dispersed network storage is not a suitable technical solution for software-only migration to a new storage platform using existing legacy server hardware. Furthermore, dispersed online storage does not reduce the potential liability to either external or internal security breaches. Once a hacker is successful in breaching all servers on an enterprise or cloud network he can steal all data files stored on that enterprise or cloud network. This is true whether the breach is via an external hacker or internal employee. There exists significant demand for an enterprise and cloud storage technology that, instead of acting to prevent security breaches, acts to eliminate or dramatically reduce the potential damage and ongoing liability that results from such breaches. The existing philosophy of prior art that attempts to stop or prevent unwanted security breaches clearly does not work against sophisticated, organized and well-funded hacker groups. New security technologies are needed that are based on the philosophy that unwanted security breaches of all online data are not only inevitable but frequent. Furthermore there exists significant demand for a secure enterprise and cloud storage technology that requires software-only migration to a new secure online platform, using existing legacy hardware or third party cloud service providers for cost effective hardware storage.

### SUMMARY OF THE INVENTION

According to the present invention there is provided a system and method for a user-managed network security architecture that securely stores individual data files in a uniquely encrypted and dispersed manner, for application in wide area enterprise networks and online cloud networks. This user-managed file-orientated security architecture provides for a software-only storage solution that has the potential to totally eliminate the liability related to external security breaches from unknown third parties, and dramatically reduce the liability related to internal security breaches from known parties or employees.

The present invention represents a significant expansion, improvement and continuation-in-part of a prior cross-related invention described by Weigold (2015) in U.S. patent application Ser. No. 14/712,715. This prior cross-related invention, from which the present invention claims benefit, in part describes the secure online storage of individual data files via a user controlled, encrypted and dispersed storage architecture. Specifically each data file is divided or spliced into multiple encrypted portions that are stored in multiple online locations, with importantly one critical file portion and the encryption key being stored on the users' local personal computer device. A unique and novel aspect to this dispersed online storage architecture for data files is the fact that, while the large majority of contents for each data file is stored online, a small critical part of each data file and the encryption key is kept by the authorized user of that specific file and stored on an authorized user device. This ultimately means that each individual authorized user has complete control of all security, privacy, distribution and access settings for each user created or user modified data file on the network. Consequently the responsibility of security and file management for network administrators is dramatically reduced. Moreover the granular file by file storage method and the user managed security architecture has dramatic consequences for dispersed online storage networks, including the viability of software-only storage solutions and the dramatic reduction in potential liability to all security breaches. The present invention represents a significant expansion of this concept for online storage of digital currency files to online storage of all data file types and data objects, applies encrypted data content hashing for improved data integrity and network reliability, and then specifically applies it to wide area enterprise storage networks and online cloud storage networks.

To summarize the present invention, it is a system and method of data storage in which each file is spliced into several portions, then encrypted, hashed and stored in multiple storage locations on an enterprise network or cloud network, with a key portion of each file and the files' encryption key stored on the user device or user devices. All authorized user devices are fingerprinted and file access requires a username and password stored on an authorized device. When accessed the complete file is formed via the hash verification, combination and decryption, of the various dispersed file portions, and only exists temporarily within an application running on an authorized user device (unless the complete file is exported to another location or application by the authorized user). The author or creator of each file has complete control over security and privacy access for that file. Network administrators cannot change individual file access settings and are only required for file back-up services from an offline storage site, in case of lost or damaged file portions on the online network or user device. Nonetheless the provision of off-line back-up storage which is not physically connected to the online network or internet is critical for the integrity of all file portions and encryption keys. In many typical cases two geo-graphically dispersed sites may be require for offline back-up storage to safeguard against a catastrophic event at either site. The user-managed dispersed online storage safeguards the data against security breaches while the off-line back-up storage safeguards against loss or destruction of the user data, user device or server data. In the case of large enterprise network applications a copy of all portions for each file and the encryption key are required to be stored at the offline back-up. In the case of an online cloud network using third party cloud storage providers only a copy of the user device file portion and encryption key may be required. For an additional security level the original file creator or author may use a “One Time” password application that requires a single username and password to access a specifically restricted file, in addition to the requirement for each user to have a username and password to access the enterprise or cloud network and their other authorized user files.

User-managed dispersed file storage architecture means that each file is 100% secure against external breaches from third party hackers, even when all online servers in an enterprise or cloud storage network are breached or hacked using a valid username and password. This is because an authorized user device is still required to access any file that is stored by the user on the network. Without possession of an authorized user device containing the critical file portion and encryption key the complete and decrypted file cannot be re-compiled or re-created. In practical terms only internal breaches (where the hacker is typically an employee) are possible, as file access requires an authorized user device as well as username and password for each specific file and file user group. As an added level of security profile “One Time Password” applications can also be implemented for each specific file thereby safeguarding against data file access even if the authorized user device is stolen and username and password is. File access and distribution is monitored and logged by an authorized file user group for each specific file (set by the file creator or author) and all authorized users in the user group are notified of any content or security changes for each file. Consequently, even if an internal breach is successful or an authorized user device is physically stolen by a third party, the maximum liability to unauthorized distribution of data is limited to the files authorized to a single user on the network.

User managed dispersed online storage of individual data files also means that file distribution can be very closely monitored and controlled by the file author and/or user group. This is because each new authorized user must register with the network and file user group to download the user device portion of the file and/or the file encryption key. The author of each file can set various levels of access for each new user including different access rights for creators, editors, viewers, distributors and guests. Moreover the relatively small data payloads of single file by file access means that large network latency and file access delays are minimized and software only architecture using existing legacy hardware is a viable option. Consequently the present invention provides for a software-only storage platform that can be integrated with existing enterprise hardware and third party cloud vendors, and has the potential to eliminate the liability to all external security breaches of the network and dramatically reduce the potential liability to internal breaches of the network. There exist numerous variations and permutations of the present invention for enterprise network and cloud storage architectures possible. The primary applications of the invention described here involve either the replacement of conventional RAID architecture in wide area enterprise networks or the use of multiple third party cloud storage providers. However various other potential embodiments of the invention may be developed without departing from the scope and ambit of the invention.

### BRIEF DESCRIPTION OF THE DRAWINGS

By way of example, employment of the invention is described more fully hereinafter with reference to the accompanying drawings, in which:

FIG. 1 shows a comparison of RAID-6 architecture, Conventional Dispersed architecture and User-Managed Encrypted Dispersed architecture applied to a typical wide area enterprise network configuration comprising of 3 online servers and 1 off-line back-up server.

FIG. 2 shows an example of User-Managed Encrypted Dispersed Cloud Storage network architecture applied to accessing a picture or image data file using 2 third party cloud storage service providers & 1 offline back-up server (off-line back-up for user device data only).

### DETAILED DESCRIPTION OF THE INVENTION:

The present invention comprises a user-managed network storage architecture that securely stores an individual data file in an encrypted and dispersed manner on a wide area enterprise network or online cloud network. This provides for a highly secure software-only enterprise class solution for the provision of encrypted hashed online data storage that minimizes the potential liability against security breaches, and combines this with a software and hardware solution for offline back-up data storage services that insures against data loss on either the online enterprise network or the users personal computer device. In the case of providing for an existing wide area enterprise network the software engine and encryption platform can typically be implemented using the customers' existing enterprise storage network hardware. In the case of providing for an online cloud storage service to general users, this can be considered the same as building a typical internal wide area enterprise storage network for internal users and employees, and then making the online storage service also available to external customers or general public.

According to a first aspect of the present invention, there is a system and method that comprises a software encryption and data storage engine controlled by the original authorized user or creator of an individual data file, which manages the encrypted hashed dispersed storage of, the and the recombined decrypted access to, the individual data file according to the following steps or processes;
the splicing or division of the content of an individual data file into three or more smaller data splices or portions;
the encryption of all data splices or portions created for an individual data file or software object using an encryption algorithm into three or more encrypted data splices or portions plus an encryption key;
the separate local storage of a single and critical encrypted data splice or portion plus the encryption key on the users local personal computer device such as a personal computer, notebook computer, tablet or smartphone device;
the separate online hashed storage of the content remaining two or more encrypted data splices or portions on two or more separately located storage servers that form a wide area enterprise network or online cloud storage network;
the retrieval and access of a complete individual data file by the authorized user or creator, by way of (i) first validating the authorization of both the user and the users personal computer device, (ii) then retrieving a hash validated copy of two or more online encrypted data splices or portions from the two or more separately located storage servers, (iii) then retrieving a copy of the single encrypted data splice or portion and the encryption key from the users local personal computer device, and (iv) the decryption and recombination of all three or more encrypted file splices or portions into a complete decrypted individual data file or that is identical to the original complete data file;
the allocation by the original authorized user of all security, privacy, editing, viewing and distribution settings for a complete individual data file to multiple users in a user group which involves the distribution of the encryption key and original authorized users encrypted data splice or portion to all authorized users in a user group; and
the regularly updated transfer and offline back-up storage of a copy of all authorized user access information, all local and online encrypted data portions and the encryption key for an individual data file, using a data storage format or server site that is not physically connected to the enterprise network or to the internet.

According to a second aspect of the present invention, at least four encrypted data splices or portions are created from an individual data file and stored separately on at least three separately located online storage servers and the users local personal computer device. The purpose of this design architecture that uses at least three online storage servers is to ensure that there exist at least two copies of each data splice stored online at any time, which has the advantage benefit of ensuring online access reliability and data content integrity in the case of damage, destruction or online access failure of one of the online storage servers on an enterprise or cloud network. Consequently this design architecture provides for both improved levels of online security and improved levels of network reliability and data integrity.

According to a third aspect of the present invention that is specifically designed for online cloud network storage services, two or more encrypted data splices or portions from an individual data file are stored separately via two or more third party cloud storage providers. In comparison to providing an online cloud storage service with an internally managed enterprise hardware network, this third party cloud design architecture has the advantages and benefits of low cost construction, low cost data storage costs and a high level of platform scalability. In addition, because typical third party cloud storage service providers already offer conventional RAID storage architecture with many copies on separate server sites and also off-line back-up data services, they already offer a high level of network reliability and data integrity. Consequently the provider or vendor of the software encryption and data storage engine does not necessarily have to provide an off-line back-up copy of the two or more encrypted data splices or portions that are stored online (as that is the responsibility of the third party provider). In this design configuration off-line back-up is only required for the user access information, the users encrypted data splice and the encryption key, and hence the total cost of providing hardware for off-line back-up services is dramatically reduced for the vendor. Nonetheless providing offline back-up storage for all online encrypted data splices or portions may provide even more network reliability and data integrity for the user.

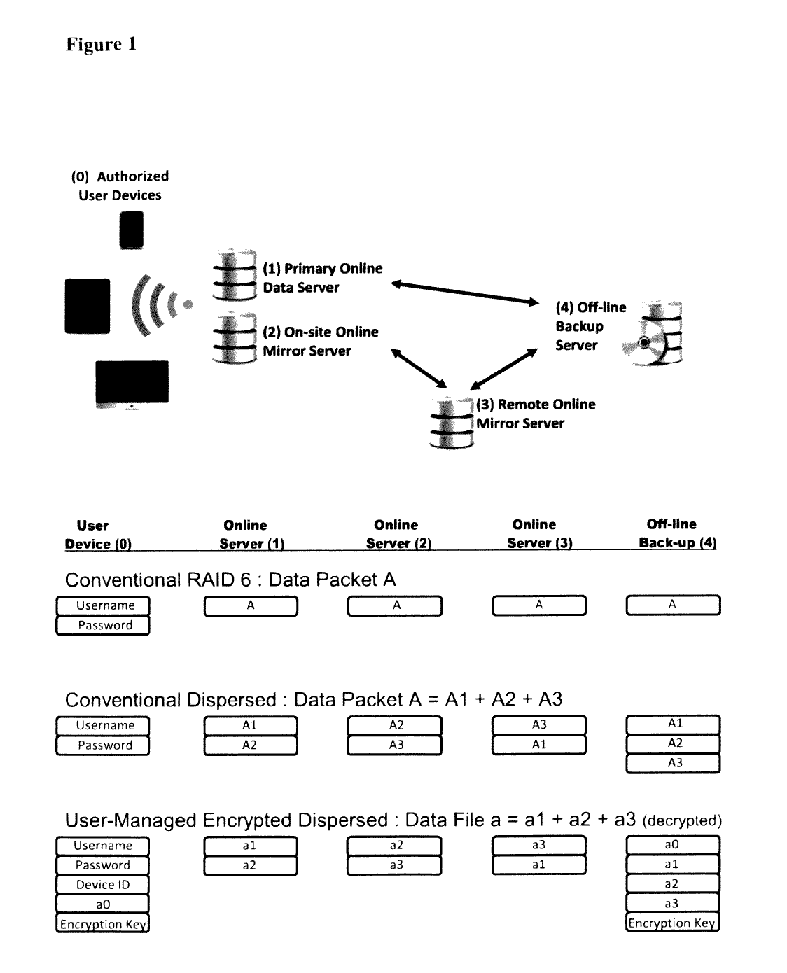

In a first embodiment of the present invention as shown in FIG. 1, a user-managed encrypted dispersed software architecture for a wide area enterprise network hardware configuration comprised of three online servers and one off-line back-up server is compared against conventional RAID-6 storage architecture and conventional dispersed storage architecture using the same fundamental hardware configuration. Because of the three separate redundant copies of all data packets stored online combined plus off-line data storage capabilities RAID-6 architecture provides for a very high level of network reliability and data integrity (in the case of the data on one or two online servers becoming damaged or destroyed). However this high level of data redundancy also provides for large total data storage costs as online storage of one petabyte of data packets stored on a RAID-6 enterprise network requires total hardware data storage capacity exceeding four petabytes of data packets (including online batch transfer and processing of offline back-up data). While conventional RAID architecture can deliver high network reliability and online data integrity it also has large hardware costs per petabyte and very high exposure to potential security breaches (as only a single server needs to be breached to gain access to all network data).

In contrast to conventional RAID architecture, conventional dispersed network architecture sacrifices some of the redundancy and network reliability of RAID architecture in return for a significant increase in network security levels. As shown in FIG. 1 for an enterprise network with three online servers, each data packet in a dispersed network is spliced or divided into three separate portions, with two data packet portions being stored on each of the three online servers in cyclic order. This means that the network can still provide authorized users all stored network data even if a single online server is damaged or destroyed (c.f. equivalent RAID-6 architecture which can withstand the simultaneous loss of two online servers). However a security breach by a hacker now requires successfully breaching two online servers, thereby making it significantly more difficult for external security breaches to occur compared to RAID architecture. Furthermore, online storage of one petabyte of data packets stored on a conventional dispersed enterprise network requires total hardware data storage capacity exceeding three petabytes of data packets (including online batch transfer and processing of offline back-up data). Consequently a dispersed network architecture results in lower hardware storage server costs and increased security compared to an equivalent RAID architecture. Nonetheless, once hackers successfully breach two online servers on this example of a dispersed enterprise network that gain access to all data stored on the network. Moreover, the long access delays and high network latency experienced when accessing a single file for a single user that is stored within a large dispersed online data packet for many users over a wide area network necessitates dedicated server hardware. In most practical scenarios conventional dispersed architecture results in more efficient and secure data storage, but still requires costly replacement of existing legacy server hardware with specifically designed server hardware that is optimized for a dispersed network design. Conventional dispersed architecture is primarily a hardware and software solution that does not reduce the potential liability relating to successful security breaches, and is also not well suited for replacement of existing RAID software architecture on existing network hardware.

In contrast to conventional dispersed architecture the first embodiment of the present invention, described as user-managed encrypted dispersed architecture in FIG. 1, provides for a software-only solution that reduces total data storage requirements on existing legacy hardware on an enterprise network and dramatically reduces the maximum potential liability relating to successful security breaches (both external and internal breaches). The data in managed, encrypted and stored by the individual user on a granular individual file level instead of larger packets of data files, which results in typical access delay and network latency being dramatically reduced when a user attempts to access a stored file (c.f. compared to file access in large data packets stored on a conventional dispersed network). Consequently a software-only solution that can be easily installed on an existing legacy RAID architecture enterprise network becomes much more viable and practical. As with conventional dispersed network architecture, user managed encrypted dispersed architecture also provides for a more efficient storage mechanism and only requires total hardware data storage capacity exceeding three petabytes of data files (including online batch transfer and processing of offline back-up data). As with dispersed storage architecture, user-managed encrypted dispersed architecture provides for significantly greater network security levels, which comes at the expense of reduced levels of online data redundancy and network reliability compared to the equivalent RAID-6 configuration. Online data integrity is maintained in the event of the failure, damage or destruction of a single online server but is not maintained in the event of two simultaneous server failures. Nonetheless this reduced network integrity compared to the equivalent RAID architecture can be easily negated with the addition of an extra fourth online server. It is important to note that the cost of an additional server for this purpose is not as much as the cost of replacing all online servers as is required by conventional server architecture.

The most important, unique and novel aspect of the present invention is that all data files are managed, encrypted and stored at the authorized users discretion, and a critical data splice or portion of each file plus the encryption key is stored locally on the authorized users personal computer device such as a desktop computer, notebook computer, tablet or smartphone device (as shown in FIG. 1). When combined with the device fingerprinting of every authorized device this both dramatically increases network security and reduces potential liability against unwanted security breaches (c.f. conventional RAID and conventional dispersed storage architecture). To successfully breach a single user data file requires access to at least two separate online server sites and an authorized user device for that specific data file (note this specifically requires physical access to the authorized user device). Even in this unlikely case, the maximum potential liability to a security breach is only those files that the specific user or owner of the user device has authorized access to. Consequently, to gain access to every data file stored on a user-managed encrypted dispersed enterprise network requires successful security breaches of all three online servers plus physical access to every individual authorized user device for every individual authorized user (including their individual usernames and passwords). The immense difficulty in achieving this type of multi-device and multi-user security penetration feat means external breaches by unknown third parties is considered to be impossible. Even if all three online servers are successfully breached and the encryption key is successfully broken all stolen data is effectively useless without the critical data portion that is stored on the user device. Consequently the potential liability to external security breaches from unknown third parties is totally eliminated. Moreover the maximum liability to internal security breaches from a known party such as an employee is dramatically reduced to only those files that the internal party has authorized access to. Furthermore, the software platform can be designed such that all file access events by all internal parties or authorized users can be monitored and logged for an additional level of security. User-managed encrypted dispersed data storage has dramatically improved network security features and also dramatically reduced potential liability to successful security breaches when compared to both conventional RAID architecture and conventional dispersed architecture.

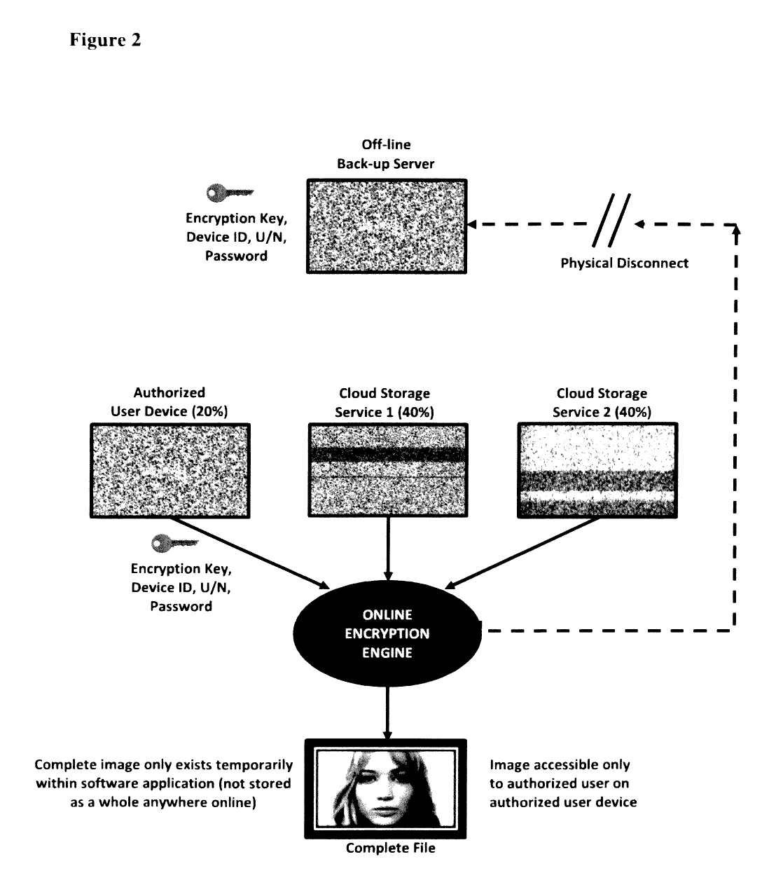

In a second embodiment of the present invention as shown in FIG. 2, user-managed encrypted dispersed storage architecture is applied to an online cloud network platform using two third party cloud service providers for all online storage of an image file as an example. Each file such as an image file can be spliced or encrypted into numerous symmetric and asymmetric configurations depending on the number of cloud service providers available. While the example shown in FIG. 2 indicates twenty percent of the file content of an image file is stored on the local authorized user device and forty percent of the file content is stored on each of the two third party cloud servers, numerous permutations of other file content distributions are possible and viable. In general, between 1% and 25% of each spliced encrypted data file portion should be stored on the authorized users' local device with the remaining 75% to 99% being stored equally between the number of online servers on the network. The optimized configuration for file content distribution and encryption is ultimately dependent upon file type, file size, user device storage capability and number of available online storage servers. This is true for both online cloud storage networks and wide area enterprise storage networks.

It is also important to note that the use of external third party storage cloud services, as opposed to building an internal wide area enterprise network for providing cloud storage services, does not require the off-line back-up storage of online data file portions stored with those third party storage service providers. This is because the third party cloud providers typically have their own multiple server redundant network architecture with off-line backup capabilities (eg: RAID or conventional dispersed architecture). While these third party service providers cannot provide high levels of network security or reduced liability against security breaches, they usually provide a very high level of network reliability and online data integrity. Nonetheless, it may be beneficial for reasons of data restoration speed or network data integrity, to keep an off-line backup copy of the encrypted file portions stored on the third party online storage servers in addition to the user devices encrypted file portion and encryption key. The example shown in FIG. 2 of user-managed encrypted dispersed cloud storage network architecture applied to accessing a picture or image data file using two third party cloud storage service providers and one offline back-up server for back-up of user device data is one of the most cost-efficient, scalable configurations possible and offers numerous advantages of conventional cloud storage service technologies and prior art.

In most preferred embodiments of the present invention discussed here, although this should not be seen as limiting the invention in any way, the invention comprises seven important processes or actions that are performed on an individual data file using a software encryption and data storage engine, namely (i) file splicing of an individual data file into three or more smaller splices, (ii) file splice encryption and encryption key creation, (iii) storage of a single encrypted file splice and encryption key on authorized user device(s), (iv) dispersed online storage of two or more encrypted file splices on a multi-server enterprise or online cloud network, (v) access, retrieval, decryption and re-combination of all stored portions only by an authorized user using a fingerprinted authorized user device, (vi) allocation of user security, privacy, editing, viewing and distribution settings to a user group by the original author or creator of the individual data file, and (vii) offline back-up storage of one or more data file splices and the encryption key in a storage format that is not physically connected to the enterprise network or internet. Although these seven important processes or actions can be considered to be sequential in many typical operating conditions, the actual order of execution of these processes or actions may change or vary as a result of either user operating instructions or architectural design considerations, and may also be repeated any number of times in any variety of executable orders or sequences.

In summary of the specific details discussed herein, the present invention can be described as a highly secure system and method for the online storage of any type of data file, that leverages a user-managed security software platform and an encrypted hashed dispersed storage architecture and applies it to wide area enterprise networks and online cloud storage services. The implications and consequences of applying a user managed security platform and user device fingerprinting with dispersed network data storage are profound and significant for the online security world. This uniquely novel and innovative design architecture offers numerous technical and commercial advantages over existing conventional online data storage technologies and prior art, including (i) the elimination of potential liabilities to external security breaches by unknown third parties of an enterprise or cloud storage network, (ii) the dramatic reduction of potential liabilities to internal security breaches by authorized users of the enterprise user group such as an employee, (iii) the dramatic increase in difficulty for hackers or thieves to execute a successful security breach, (iv) the reduction in total hardware server infrastructure requirements and costs for a reliable redundant data storage network offering network reliability and data integrity against server failure or damage, and (v) the implementation of secure storage architecture using software-only solutions that simply and cost-effectively integrate with existing legacy network hardware infrastructure or third party cloud storage architecture. The present invention represents a significant and innovative advance in online data storage applied to enterprise network and cloud storage environments. Various modifications may be made in details of design and construction of the invention and its component parts, process steps, parameters of operation etc. without departing from the scope and ambit of the invention.

What is claimed is:

1. A system and method for a software encryption and data storage engine controlled and managed by the original authorized user or creator of an individual data file, which manages the encrypted dispersed storage of, and the decrypted recombined access to, the individual complete data file stored on a wide area enterprise data storage network according to the following steps or processes;
the splicing or division of the content of an individual data file into three or more smaller data file splices or portions;
the encryption of all data splices or portions created for an individual data file using an encryption algorithm into three or more encrypted data splices or portions plus an encryption key;
the separate local storage of a single and critical encrypted data splice or portion plus the encryption key on the users local personal computer device such as a personal computer, notebook computer, tablet or smartphone device;
the separate online storage of the remaining two or more encrypted data splices or portions on two or more separately located storage servers that form a wide area enterprise network;
the retrieval and access of a complete individual data file by the authorized user or creator, by way of (i) first validating the authorization of both the user and the users personal computer device, (ii) then retrieving a copy of two or more online encrypted data splices or portions from the two or more separately located storage servers, (iii) then retrieving a copy of the single encrypted data splice or portion and the encryption key from the users local personal computer device, and (iv) the recombination and decryption of three or more encrypted file splices into a complete decrypted individual data file that is identical to the original complete data file;
the allocation by the original authorized user of all security, privacy, editing, viewing and distribution settings for a complete individual data file to multiple users in a user group, which involves the distribution of the encryption key and original authorized users encrypted data splice or portion to all authorized users in an authorized user group; and
the regularly updated or continual transfer and offline back-up storage of a copy of all authorized user access information, all local and online encrypted data portions and the encryption key for an individual data file, using a data storage format or server site that is not physically connected to the enterprise network or to the internet.

2. A system and method for a software encryption and data storage engine controlled by the original authorized user or creator of an individual data file, which manages the encrypted dispersed storage of, and the recombined decrypted access to, the individual complete data file stored on an online cloud storage service network according to the following steps or processes;
the splicing or division of the content of an individual data file into three or more smaller data file splices or portions;
the encryption of all data splices or portions created for an individual data file using an encryption algorithm into three or more encrypted data splices or file portions plus an encryption key that is essential to decrypting all data splices;
the separate local storage of a single and critical encrypted data splice or portion plus the encryption key on the users local personal computer device such as a personal computer, notebook computer, tablet or smartphone device;
the separate online storage of the remaining two or more encrypted data splices or portions on two or more separately located storage servers that form an online cloud storage network;
the retrieval and access of a complete individual data file by the authorized user or creator, by way of (i) first validating the authorization of both the user and the users personal computer device, (ii) then retrieving a copy of two or more online encrypted data splices or portions from the two or more separately located storage servers, (iii) then retrieving a copy of the single encrypted data splice or portion and the encryption key from the users local personal computer device, and (iv) the recombination and decryption of three or more encrypted file splices into a complete decrypted individual data file that is identical to the original complete data file;
the allocation by the original authorized user of all security, privacy, editing, viewing and distribution settings for a complete individual data file to multiple users in a user group, which involves the distribution of the encryption key and original authorized users encrypted data splice or portion to all authorized users in a user group; and
the regularly updated or continual transfer and offline back-up storage of a copy of one or more of the all authorized user access information, all local and online encrypted data portions and the encryption key for an individual data file using a data storage format or server site that is not physically connected to the enterprise network or to the internet.

3. The system and method of claim 1, wherein the data file comprises information stored in data file formats or types including but not limited to image files, video files, audio files, text files, legal documents, financial documents, medical history documents, word processor documents, presentation documents, spreadsheet documents, email documents, database files, relational data base files, object oriented database files and big data files.

4. The system and method of claim 2, wherein the data file comprises information stored in data file formats or types including but not limited to image files, video files, audio files, text files, legal documents, financial documents, medical history documents, word processor documents, presentation documents, spreadsheet documents, email documents, database files, relational data base files, object oriented database files and big data files.

5. The system and method of claim 1, wherein the data file comprises information stored in document file formats or types including confidential, personal or financial information including but not limited to credit card details, bank account details, internet usernames, internet passwords, social security numbers, tax identification numbers, passport details and drivers' license details.

6. The system and method of claim 2, wherein the data file comprises information stored in document file formats or types including confidential, personal or financial information including but not limited to credit card details, bank account details, internet usernames, internet passwords, social security numbers, tax identification numbers, passport details and drivers' license details.

7. The system and method of claim 1, wherein the data file is an actively operating or live software object such as a streaming video, streaming audio or interactive software application file.

8. The system and method of claim 2, wherein the data file is an actively operating or live software object such as a streaming video, streaming audio or interactive software application file.

9. The system and method of claim 1, wherein the user-managed encrypted dispersed storage architecture is implemented via a software-only installation procedure on an existing legacy server hardware infrastructure, typically owned by an enterprise class customer.

10. The system and method of claim 1, wherein the user-managed encrypted dispersed storage architecture is implemented via the combination of a software platform integrated with new or greenfield server hardware architecture to create a highly secure new or greenfield server network.

11. The system and method of claim 2, wherein the user-managed encrypted dispersed storage architecture is implemented via integration with multiple third party cloud service providers for online data storage of each file splice or portion, and provided to the user by a single amalgamated cloud service vendor who provides the software platform and links to third party cloud providers.

12. The system and method of claim 1, wherein the username and password required to access each file is managed using a one-time password application that requires the user to only remember a single username and password to have authorized access to either multiple user files or to a single specific restricted file.

13. The system and method of claim 2, wherein the username and password required to access each file is managed using a one-time password application that requires the user to remember a single username and password to have authorized access to either multiple user files or to a single specific restricted file.

14. The system and method of claim 1, wherein the content of the encrypted data file portions are stored using a hash data format with a hash table and hash function, for improved data integrity and faster data access speeds.

15. The system and method of claim 2, wherein the content of the encrypted data file portions are stored using a hash data format with a hash table and hash function, for improved data integrity and faster data access speeds.

16. The system and method of claim 1, wherein the authorized users' encrypted data file portion and/or encryption key is stored on a virtual private network instead of on the authorized user device.

17. The system and method of claim 2, wherein the authorized users' encrypted data file portion and/or encryption key is stored on a virtual private network instead of on the authorized user device.

18. The system and method of claim 2, wherein the authorized user can select or provide his own personal data storage server or third party cloud storage service to integrate with the dispersed cloud storage grid.

19. The system and method of claim 1, wherein the data encryption process occurs before the individual data file is spliced or divided into three or more data splices or portions.

20. The system and method of claim 2, wherein the data encryption process occurs before the individual data file is spliced or divided into three or more data splices or portions.

21. The system and method of claim 1, wherein multiple encryption processes are used to encrypt the individual data files, including the case when encryption processes are performed before and after the data file is spliced or divided into three or more data splices or portions;

22. The system and method of claim 2, wherein multiple encryption processes are used to encrypt the individual data files, including the case when encryption processes are performed both before and after the data file is spliced or divided into three or more data splices or portions;

23. The system and method of claim 2, wherein the user-managed encrypted dispersed storage architecture is implemented via internal construction and provision by a vendor of a wide area enterprise network that offers multiple geo-dispersed storage server locations that acts as a highly secure cloud storage service.

24. The system and method of claim 1 and claim 2, wherein the software encryption and data storage engine is a hybrid construction of the architecture for enterprise networks described in claim 1 combined with the architecture for online cloud storage services described in claim 2.
